(19) United States
(12) Patent Application Publication
(10) Pub. No.: US 2024/0129333 A1
(43) Pub. Date: Apr. 18, 2024

(54) SERVER APPARATUS, INFORMATION PROCESSING APPARATUS, AND STORAGE MEDIUM

(71) Applicant: CANON KABUSHIKI KAISHA, Tokyo (JP)

(72) Inventors: YUKI MINETOMO, Kanagawa (JP); NOBUHIRO TAGASHIRA, Chiba (JP); TAKAMI EGUCHI, Tokyo (JP); AYUTA KAWAZU, Kanagawa (JP)

(21) Appl. No.: 18/486,981

(22) Filed: Oct. 13, 2023

(30) Foreign Application Priority Data
Oct. 14, 2022 (JP) 2022-165567

(51) Int. Cl. H04L 9/40

(52) U.S. Cl. CPC H04L 63/1433; H04L 63/1441

(57) ABSTRACT

A server apparatus includes one or more memories and one or more processors. The one or more processors and the one or more memories are configured to acquire vulnerability information about an information processing apparatus, acquire information about a network to which the information processing apparatus is connected, and transmit, to the information processing apparatus, vulnerability countermeasure information based on the vulnerability information and the information about the network.

### BACKGROUND

### Field of the Disclosure

The present disclosure relates to a server apparatus configured to acquire vulnerability information, an information processing apparatus, an information processing method, and a storage medium.

### Description of the Related Art

In recent years, the damage caused by cyberattacks exploiting vulnerabilities of information processing apparatuses is increasing, and addressing vulnerabilities promptly has been considered important. Vulnerability information is widely published and is accessible to the public. Since the published information is wide-ranging, it is necessary to scrutinize the published information, analyze which information is relevant, and then apply a vulnerability countermeasure to the information processing apparatus in need of a countermeasure in order to apply an appropriate countermeasure to an information processing apparatus.

According to Japanese Patent No. 6735996, vulnerability information and countermeasure data about the vulnerability information are collected from a published vulnerability database. The collected information is then checked against information about hardware and software resources owned in an organization to identify a vulnerability countermeasure target, and then countermeasure data is generated and distributed.

However, Japanese Patent No. 6735996 does not discuss determining necessity for a countermeasure considering a network environment of an information processing apparatus. Vulnerability information includes conditions prior to attack exploiting vulnerabilities as well as details of the vulnerabilities. For example, the publicly-known Common Vulnerability Scoring System (CVSS) discusses “Attack Vector” (local, network, adjacent) and “Attack Complexity” (whether any preparation such as the acquisition of session information is required prior to attack) of vulnerability information. Furthermore, information such as “Privileges Required” (basic user privileges, privileged user privileges) for attack is also published. Applying a vulnerability countermeasure to an information processing apparatus without considering the foregoing information can cause a decrease in usability.

For example, there may be a case where the collection of setting values of an information processing apparatus and session information is required for the attacks that exploit vulnerabilities. In an environment, such as an office environment, where network boundaries are protected by a proxy server or a firewall, it may be difficult to collect the above-described information. The vulnerability of such an environment thereby becomes low compared to an environment without network boundary defense. In this case, applying a countermeasure to disable a function as a vulnerability countermeasure can cause an excessive decrease in usability. The excessive decrease in usability can be prevented by determining whether the vulnerability countermeasure is necessary depending on the network environment of the information processing apparatus. For this purpose, it is necessary to identify which network environment the information processing apparatus is connected to. According to Japanese Patent No. 6735996, the network environment of the information processing apparatus is not identified, and the relationship between the network environment of the information processing apparatus and the vulnerability information is unspecified. It is therefore difficult to perform a proper determination of whether to apply a vulnerability countermeasure.

### SUMMARY

Some embodiments of the present disclosure are directed to performing a proper determination of whether to apply a vulnerability countermeasure to an information processing apparatus.

According to an aspect of the present disclosure, a server apparatus includes one or more memories and one or more processors. The one or more processors and the one or more memories are configured to acquire vulnerability information about an information processing apparatus, acquire information about a network to which the information processing apparatus is connected, and transmit, to the information processing apparatus, vulnerability countermeasure information based on the vulnerability information and the information about the network.

Further features of various embodiments will become apparent from the following description of exemplary embodiments with reference to the attached drawings.

### BRIEF DESCRIPTION OF THE DRAWINGS

FIG. 1 is a block diagram illustrating a form of connection between multi-function peripherals (MFPs) and peripheral devices according to an aspect of the present disclosure.

FIG. 2 is a diagram illustrating an internal configuration of a controller unit of an MFP according to an aspect of the present disclosure.

FIG. 3 illustrates a functional configuration of an MFP according to an aspect of the present disclosure.

FIG. 4 illustrates a functional configuration of a management server according to an aspect of the present disclosure.

FIG. 5 illustrates vulnerability countermeasure settings according to a first exemplary embodiment.

FIG. 6 illustrates an MFP-network environment correspondence table according to the first exemplary embodiment.

FIG. 7 illustrates vulnerability profiles according to the first exemplary embodiment.

FIG. 8 illustrates environment profiles according to the first exemplary embodiment.

FIG. 9 illustrates an environment-vulnerability correspondence table according to the first exemplary embodiment.

FIGS. 10A and 10B are flowcharts illustrating a process according to the first exemplary embodiment.

FIGS. 11A and 11B illustrate functional configurations of an MFP and a management server according to a second exemplary embodiment.

FIG. 12 illustrates vulnerability countermeasure information according to the second exemplary embodiment.

FIGS. 13A and 13B are flowcharts illustrating a process according to the second exemplary embodiment.

FIG. 14 illustrates a functional configuration of an MFP according to a third exemplary embodiment.

FIG. 15 is a flowchart illustrating a process according to the third exemplary embodiment.

### DESCRIPTION OF THE EMBODIMENTS

Information processing apparatuses according to exemplary embodiments of the present disclosure will be described in detail below with reference to the drawings. In the exemplary embodiments, vulnerability information and a network environment of an information processing apparatus are analyzed, and processing for identifying an information processing apparatus that needs a vulnerability countermeasure and delivering a vulnerability countermeasure settings will be described. In the present description of the exemplary embodiments, a multi-function peripheral (MFP) serving as an image forming apparatus will be described as an example of an information processing apparatus. However, aspects of the present disclosure are also applicable to information processing apparatuses other than MFPs.

(Apparatus Configuration according to First Exemplary Embodiment)

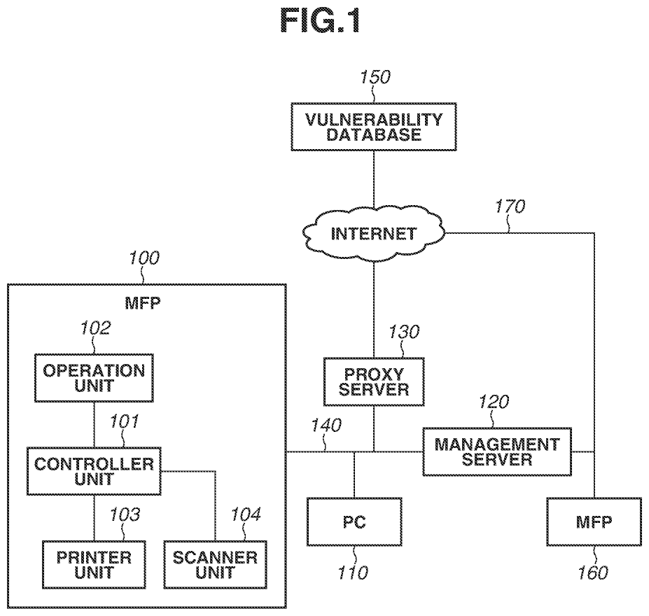

A form of connection between MFPs and peripheral devices according to a first exemplary embodiment of the present disclosure will now be described with reference to a block diagram in FIG. 1. An MFP 100, a personal computer (PC) 110, and a management server 120 are connected together via a local area network (LAN) 140. Further, an MFP 160 and the management server 120 are connected via a LAN 170. The PC 110 performs processing, such as transmission and reception of print jobs and scan jobs to and from the MFP 100. The management server 120 is connected to the LANs 140 and 170 and manages the MFPs 100 and 160. The management server 120 also communicates with a vulnerability database 150 via the Internet to collect vulnerability information. The MFP 100 and the management server 120 connect to the Internet via a proxy server 130. The MFP 160 connects to the Internet directly via the LAN 170 without the proxy server 130.

The MFP 100 includes an operation unit 102. Input from a user and output to the user are performed via the operation unit 102. The MFP 100 includes a printer unit 103, and the printer unit 103 outputs electronic data to a paper medium. The MFP 100 includes a scanner unit 104, and the scanner unit 104 scans a paper medium and converts the scanned data into electronic data. The operation unit 102, the printer unit 103, and the scanner unit 104 are connected to a controller unit 101 and realize functions as an MFP based on control by the controller unit 101. The client PC 110 performs processing, such as transmission and reception of print jobs and scan jobs to and from the MFP 100.

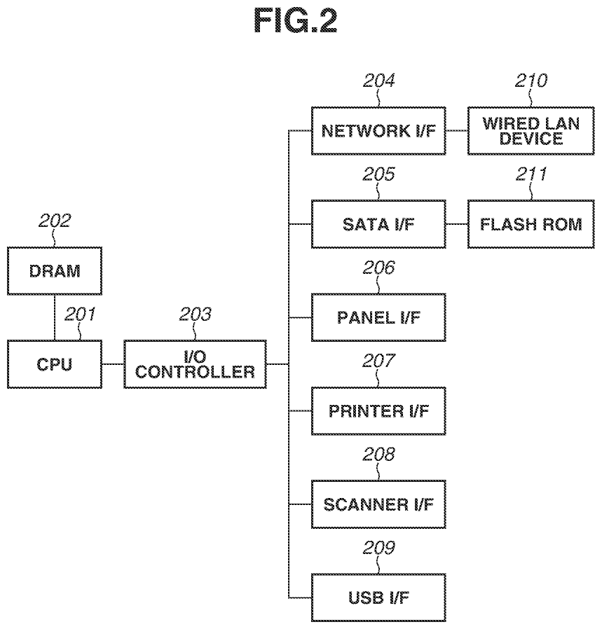

FIG. 2 is a block diagram illustrating a physical configuration of the controller unit 101 of the MFP 100. A central processing unit (CPU) 201 performs main computation processing in the controller unit 101. The CPU 201 is connected to a dynamic random access memory (DRAM) 202 via a bus. The DRAM 202 is used by the CPU 201 as a work memory for temporarily storing program data specifying computation instructions during a computation process by the CPU 201 and processing target data. The CPU 201 is connected to an input/output (I/O) controller 203 via the bus. The I/O controller 203 controls input and output to and from various devices based on instructions from the CPU 201. The I/O controller 203 is connected to a serial advanced technology attachment (SATA) interface (I/F) 205, and the SATA I/F 205 is connected to a flash read-only memory (flash ROM) 211. The CPU 201 uses the flash ROM 211 to permanently store programs for realizing functions of the MFP 100 and document files. The I/O controller 203 is connected to a network I/F 204. The network I/F 204 is connected to a wired LAN device 210.

The CPU 201 realizes communication on the LAN 140 by controlling the wired LAN device 210 via the network I/F 204. The I/O controller 203 is connected to a panel I/F 206, and the CPU 201 realizes input and output to and from the operation unit 102 for the user via the panel I/F 206. The I/O controller 203 is connected to a printer I/F 207, and the CPU 201 realizes output processing to a paper medium using the printer unit 103 via the printer I/F 207. The I/O controller 203 is connected to a scanner I/F 208, and the CPU 201 realizes document scan processing using the scanner unit 104 via the scanner I/F 208. The I/O controller 203 is connected to a universal serial bus (USB) I/F 209 and controls a device connected to the USB I/F 209.

In performing a copy function, the CPU 201 reads program data to the DRAM 202 from the flash ROM 211 via the SATA I/F 205. The CPU 201 detects a copy instruction from the user to the operation unit 102 via the panel I/F 206 based on the program data read to the DRAM 202. When a copy function is detected, the CPU 201 receives a document in the form of electronic data from the scanner unit 104 via the scanner I/F 208 and stores the received electronic data in the DRAM 202. The CPU 201 performs processing, such as color conversion processing, suitable for the output with respect to image data stored in the DRAM 202. The CPU 201 transfers the image data stored in the DRAM 202 to the printer unit 103 via the printer I/F 207 and performs output processing on a paper medium.

In performing page description language (PDL) printing, the client PC 110 issues a printing instruction via the LAN 140. The CPU 201 reads program data from the flash ROM 211 to the DRAM 202 via the SATA I/F 205, and detects a printing instruction via the network I/F 204 based on a module read to the DRAM 202. When a PDL transmission instruction is detected, the CPU 201 receives print data via the network I/F 204 and stores the print data in the flash ROM 211 via the SATA I/F 205. After completing the storage of the print data, the CPU 201 develops the print data stored in the flash ROM 211 to the DRAM 202 as image data. The CPU 201 performs processing, such as color conversion processing, suitable for the output with respect to the image data stored in the DRAM 202. The CPU 201 transfers the image data stored in the DRAM 202 to the printer unit 103 via the printer I/F 207 and performs output processing on a paper medium.

Functional configurations and processing flows according to the present exemplary embodiment will be described below.

### (Functional Configuration According to First Exemplary Embodiment)

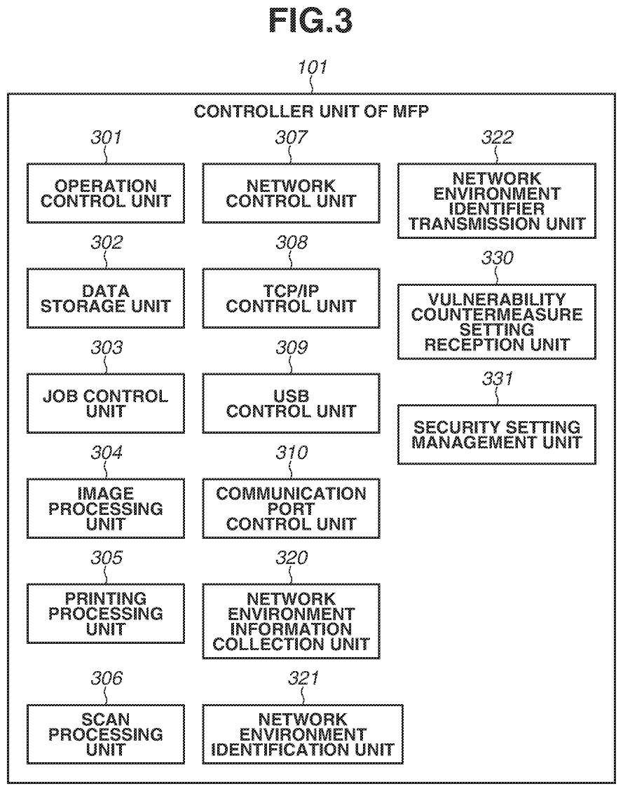

An example of a functional configuration to be realized by software executed by the controller unit 101 of the MFP 100 according to the first exemplary embodiment will now be described with reference to a block diagram in FIG. 3.

An operation control unit 301 displays a screen image for the user on the operation unit 102, detects user operations, and performs processing associated with a screen component, such as a button, displayed on the screen.

A data storage unit 302 stores data in the flash ROM 211 and reads the data from the flash ROM 211 based on requests from other control units. For example, when the user changes a device setting, the operation control unit 301 detects content input to the operation unit 102 by the user, and the data storage unit 302 stores the detected content as a setting value in the flash ROM 211 based on a request from the operation control unit 301. A job control unit 303 controls job execution based on instructions from other control units. An image processing unit 304 processes image data into a form suitable for a purpose of use based on an instruction from the job control unit 303. A printing processing unit 305 prints an image on a paper medium via the printer OF 207 based on an instruction from the job control unit 303, and outputs the paper medium. A scan processing unit 306 scans a placed document via the scanner OF 208 based on an instruction from the job control unit 303. A network control unit 307 performs configuration of a network setting, such as an Internet Protocol (IP) address, on a Transmission Control Protocol over IP (TCP/IP) control unit 308 based on setting values stored in the data storage unit 302 during system activation or when a setting change is detected.

The TCP/IP control unit 308 performs network packet transmission/reception processing via the network OF 204 based on instructions from other control units.

A USB control unit 309 controls the USB OF 209 and controls a USB-connected device.

A communication port control unit 310 controls ports that are used by the TCP/IP control unit 308 in performing packet transmission/reception.

A network environment information collection unit 320 collects setting value information about the MFP 100 stored in the data storage unit 302, and information acquired from other devices, such as a Domain Name System (DNS) server and a Dynamic Host Configuration Protocol (DHCP) server, located within the network to which the MFP 100 belongs. Hereinafter, the other devices located within the network will be referred to as “network devices”. Examples of setting information about the MFP 100 include an IP address, a type of the IP address (global address, private address), and a setting to enable or disable the proxy server 130 when the MFP 100 communicates with a device outside the LAN 140. Examples of setting information about the MFP 100 also include setting information about a protocol to be used in communication and setting information about a network environment stored in the data storage unit 302 of the MFP 100. Examples of information acquired from network devices include an IP address of a transmission source of a packet received by the MFP 100, a type of the IP address (global address, private address), and a port used in the communication. Examples of information acquired from the network devices also include time-to-live (TTL) information about the packet, a response to the Address Resolution Protocol (ARP) that has been transmitted by the MFP 100, a response from the DNS server, and option information about the DHCP server. While various types of information are described above as examples of information that the network environment information collection unit 320 collects, it is also possible to refer to other information that the MFP 100 can collect. Hereinafter, the setting values of the MFP 100 and the information acquired from the network devices will be referred to as network environment information. The collected network environment information is stored in the data storage unit 302. The processing of the network environment information collection unit 320 is started in a case where operation is started or an instruction is issued by the user or the management server 120.

A network environment identification unit 321 identifies the network environment to which the MFP 100 is connected as a predefined network environment, such as small office home office (SOHO), public, or intranet, based on the network environment information collected by the network environment information collection unit 320. The network environments match network environments described in an environment profile 801 (described below) of the management server 120. While the foregoing network environments are described as examples of the network environment of the MFP 100, the network environment of the MFP 100 can be identified as another environment. Hereinafter, the network environment of the MFP 100 that is identified from a security perspective based on the network environment information about the network environment to which the MFP 100 is connected will be referred to as “network environment identifier”. The network environment identification can be performed using, for example, the following method. Specifically, in a case where a proxy setting of the MFP 100 or communication from the proxy server 130 is detected, the network environment is identified as an intranet environment to which the network boundary defense by the proxy server 130 is applied, and the intranet environment is used as a network environment identifier. In a case where no network boundary defense is applied to a network environment, unlike the intranet environment, but the network environment is operated on a private network, the network environment is identified as a SOHO environment, and the SOHO environment is used as a network environment identifier. In a case where a network environment can be accessed by a large number of unspecified users because a global address is set as an IP address or direct communication with an external server or a client is performed, the network environment is identified as a public environment, and the public environment is used as a network environment identifier. In the example in FIG. 1, the MFP 100 is connected to the external entities via the proxy server 130, and in this case, the MFP 100 is determined as being in an intranet environment. The MFP 160 is determined as being in a public environment because the MFP 160 is directly connected to the Internet without a proxy server. The method described above as an example is a rule-based determination method that identifies a network environment based on a specific condition. Alternatively, the network environment identification can be performed using artificial intelligence (AI) trained on relationships between the collected network environment information and the network environment identifiers or can be performed using another method.

A network environment identifier transmission unit 322 transmits the network environment identifier identified by the network environment identification unit 321 and device information to the management server 120. As the device information, information that can identify the MFP 100, such as a device name, IP address, and Media Access Control (MAC) address of the MFP 100, is used.

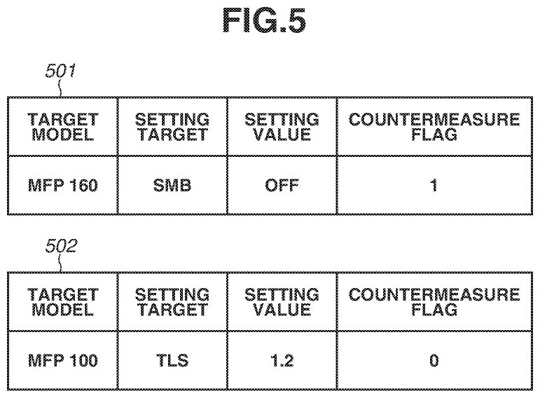

A vulnerability countermeasure setting reception unit 330 receives a vulnerability countermeasure setting 501 or 502 transmitted from the management server 120. The vulnerability countermeasure settings 501 and 502 are illustrated in FIG. 5 and will be described below.

A security setting management unit 331 performs updating of settings and notification to an administrator based on the vulnerability countermeasure setting 501 or 502 received by the vulnerability countermeasure setting reception unit 330. A process of updating the settings of the MFP 100 by the security setting management unit 331 based on the vulnerability countermeasure setting 501 or 502 will now be described with reference to FIG. 5. The vulnerability countermeasure settings 501 and 502 describe vulnerability countermeasure settings. An item “target model” describes an identifier (ID) of a setting target device. An item “setting target” describes a type of a setting to which a vulnerability countermeasure should be applied. An item “setting value” describes a value that should be set to apply a vulnerability countermeasure. An item “countermeasure flag” describes a flag indicating whether execution of the vulnerability countermeasure setting is necessary. In a case where the countermeasure flag is “1”, it is determined that the vulnerability countermeasure is necessary, and the MFP settings are changed and then the notification to the administrator is performed. In a case where the countermeasure flag is “0”, it is determined that the vulnerability countermeasure is unnecessary, and only the notification to the administrator is performed. For example, the vulnerability countermeasure setting 501 describes the setting value for applying the vulnerability countermeasure to a Server Message Block (SMB) setting. Since the target model of the vulnerability countermeasure setting 501 is the MFP 160 and the countermeasure flag is “1”, the vulnerability countermeasure is necessary. Thus, the MFP 160 changes the setting value of “SMB” to “OFF” described in the vulnerability countermeasure setting 501 and then performs notification to the administrator. In contrast, the vulnerability countermeasure setting 502 describes the setting value for applying the vulnerability countermeasure to a Transport Layer Security (TLS) setting. Since the target model is the MFP 100 and the countermeasure flag is “0”, the MFP 100 does not change the settings and notifies the administrator that it is recommended that the setting value of “TLS” should be set to “1.2”. While the settings and the setting values are described above as examples of vulnerability countermeasure settings, it is also possible to use patches for vulnerabilities that are published by an MFP vendor or a software vendor or other information.

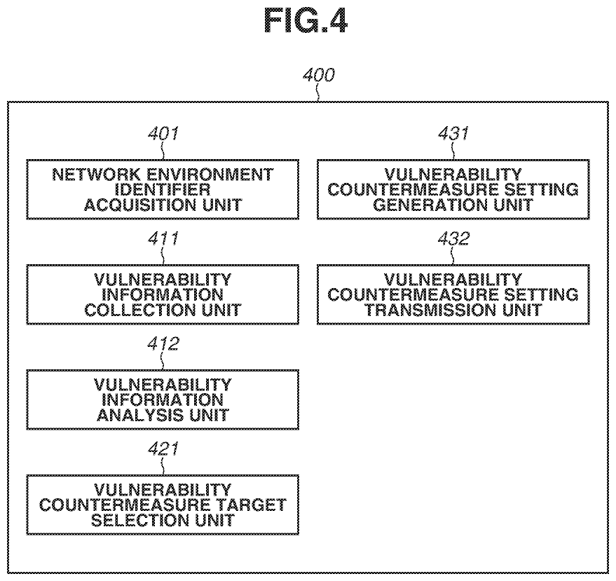

An example of a functional configuration that is realized by software executed by the management server 120 according to the first exemplary embodiment will now be described with reference to a block diagram in FIG. 4.

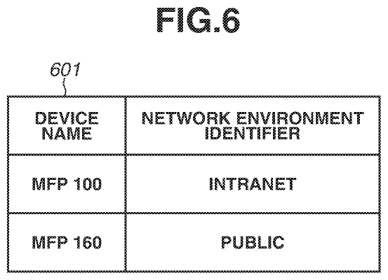

A network environment identifier acquisition unit 401 acquires device information and network environment identifier information about the MFPs 100 and 160 being managed by the management server 120. The acquired device information and the network environment identifiers of the MFPs 100 and 160 are stored in an MFP-network environment correspondence table 601 illustrated in FIG. 6 described below. The MFP-network environment correspondence table 601 describes device information and network environment identifiers that have been transmitted from the management target MFPs 100 and 160.

The MFP-network environment correspondence table 601 describes the device names of the MFPs 100 and 160 and the network environment identifiers “intranet” and “public” of the MFPs 100 and 160, respectively. While a case where the device information described in the MFP-network environment correspondence table 601 is a device name is described above as an example, it is also possible to describe other device information.

A vulnerability information collection unit 411 collects vulnerability information from the vulnerability database 150.

As to an example of the vulnerability database 150, for example, the publicly-known Japan Vulnerability Notes (JVN) can be referred to. Further, a database that publishes vulnerability information, such as the Common Vulnerabilities and Exposures (CVE) or the National Vulnerability Database (NVD), or a database published by MFP vendors can be referred to. While the foregoing databases are described as examples of the vulnerability database 150, it is also possible to refer to other databases. Vulnerability information to be collected by the vulnerability information collection unit 411 is limited to information that relates to a management target information processing apparatus. For example, since the management target information processing apparatuses according to the present exemplary embodiment are the MFPs 100 and 160, a search is performed using information about protocols, ports, software, and hardware that are used by the MFPs 100 and 160, vendor names, device names, and model numbers as keywords. In other words, vulnerability information to be collected is only limited to information that relates to the MFPs 100 and 160. While a case where related vulnerability information is collected using keywords that relate to the MFPs 100 and 160 is described above as an example, the identification of related vulnerability information can be performed by a process using AI or natural language processing technologies.

A vulnerability information analysis unit 412 analyzes vulnerability information collected by the vulnerability information collection unit 411. In the vulnerability information analysis, the information of the publicly-known Common Vulnerability Scoring System (CVSS) can be used. CVSS describes “Attack Vector” indicating a possible exploitation of a vulnerability to attack and “Privileges Required” indicating a level of user privileges required prior to attack.

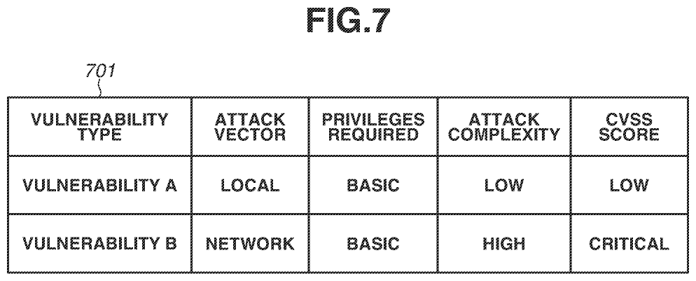

Further, CVSS also describes “Attack Complexity” indicating whether advance preparation, such as the collection of attack target setting values and session information, is required prior to attack and “CVSS score” indicating a vulnerability severity. The vulnerability information analysis unit 412 generates a vulnerability profile 701 illustrated in FIG. 7 to be described below with respect to vulnerabilities collected based on the above-described information. The vulnerability profile 701 describes analysis results based on the CVSS scoring items for each vulnerability. The examples illustrated in FIG. 7 describe analysis results based on CVSS scoring results of a vulnerability A, which is a vulnerability relating to SMB, and a vulnerability B, which is a vulnerability relating to TLS. The vulnerability A is a vulnerability that confidential information may be leaked by accessing the confidential information from a local environment using basic user privileges and performing an unauthorized operation in a case where the SMB protocol is used. The following vulnerability profile is obtained based on the CVSS scoring results on the vulnerability A. The Attack Vector is “local” because “attacks can be carried out only locally”. The Privileges Required is “basic” because “attacks require privilege levels higher than or equal to basic users”. The Attack Complexity is “low” because “no advance preparation is required prior to attack”. The CVSS score is “low” because “an impact of attack requires attention”. The vulnerability B is a vulnerability that an encrypted message may be decrypted on a communication path in a case where TLS version 1.1 or lower is used. Similarly to the vulnerability A, a vulnerability profile based on CVSS scoring results is obtained for the vulnerability B. The Attack Vector is “network” because “attacks can be carried out via network access”. The Privileges Required is “basic” because “attacks require privileges higher than or equal to basic users”. The Attack Complexity is “high” because “advance preparation is required prior to attack”.

The CVSS score is “critical” because “an impact of attack is critical”. While a case where a vulnerability profile is generated using CVSS is described above as an example, it is also possible to use other vulnerability information, or an analysis using AI or natural language processing can also be performed.

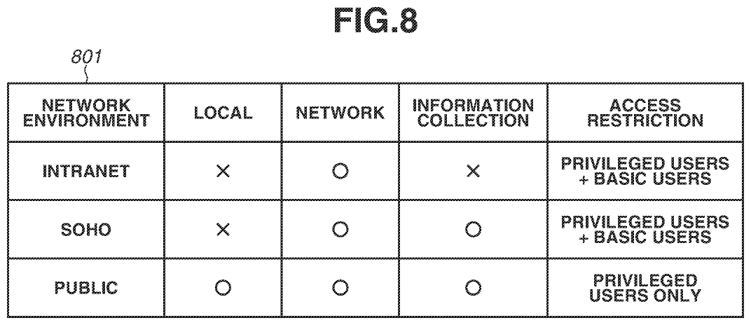

A vulnerability countermeasure target selection unit 421 selects a network environment that needs application of a countermeasure to a vulnerability collected by the vulnerability information collection unit 411. In the identification of an environment that needs a vulnerability countermeasure, the vulnerability profile 701 and the environment profile 801 in FIG. 8 are used. The environment profile 801 is predefined by the management server 120 and will be described below. The environment profile 801 presents a profile for each network environment of the MFPs 100 and 160. The environment profile 801 presents conditions of environment profiles corresponding to the network environments. An item “local” indicates whether the MFPs 100 and 160 can be accessed locally, and an item “network” indicates whether the MFPs 100 and 160 can be accessed via network. Further, an item “information collection” indicates whether information for attack can be collected in advance. An item “access restriction” indicates a level of privileges set for the MFPs 100 and 160. An environment profile for each network environment will now be described with reference to FIG. 8. Since the intended intranet environment is a general office environment, it is assumed that local access is restricted by entry management. Thus, the MFPs 100 and 160 cannot be accessed locally and are allowed to be accessed only via network. Further, since the network boundary defense using firewalls and proxy servers is implemented, it is difficult to perform preparation, such as collection of setting value information about the MFPs 100 and 160, and acquisition of session information prior to attack. As to the access restriction, basic users and privileged users are set. The SOHO environment is similar to the intranet environment, except that, unlike the intranet environment, no countermeasures, such as the network boundary defense, are applied and preparation, such as information collection prior to attack, can be performed. In the public environment, the MFPs 100 and 160 are intended to be used by a large number of unspecified users, so that anyone can access the MFPs 100 and 160 locally, and only privileged users are set for “access restriction”. While the access source, the difficulty of information collection, and the presence or absence of access restriction are used herein as an environment profile of the MFPs 100 and 160, it is also possible to use other information.

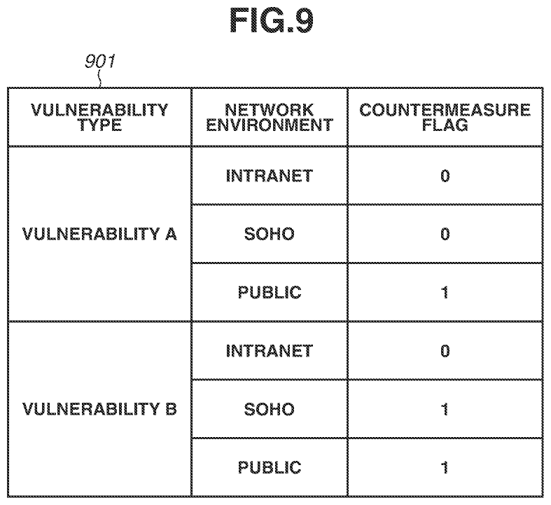

The vulnerability countermeasure target selection unit 421 selects an environment that satisfies the conditions of the vulnerability profile 701 by referring to the environment profile 801. For example, the Attack Vector of the vulnerability A described in the vulnerability profile 701 in FIG. 7 is “local”, so that local access is required to attack the vulnerability A. Thus, it is analyzed that attack exploiting the vulnerability A can be carried out only in the public environment that can be accessed locally. Further, prior information collection is required to attack the vulnerability B, so that it is analyzed that attack exploiting the vulnerability B can be carried out in the SOHO environment and the public environment where the information collection can be performed. As described above, an environment is identified as an environment that needs a vulnerability countermeasure in a case where the conditions of the vulnerability profile 701 match the conditions of the environment profile 801. The foregoing analysis results are recorded in an environment-vulnerability countermeasure table 901 illustrated in FIG. 9, which will be described below. The environment-vulnerability countermeasure table 901 describes analyzed vulnerability types and information indicating whether a countermeasure is necessary for each environment. Whether a vulnerability countermeasure is necessary is specified by a countermeasure flag, and in a case where the countermeasure flag is “1”, “a countermeasure is necessary”, whereas in a case where the countermeasure flag is “0”, “a countermeasure is optional”. For example, in the analysis results of the vulnerability A, since MFPs in the public environment are an environment that needs a countermeasure, the countermeasure flag corresponding to the public environment is “1”, whereas the countermeasure flags corresponding to the other environments are “0”. In the analysis results of the vulnerability B, since the SOHO environment and the public environment are environments that need a countermeasure, the countermeasure flags corresponding to the SOHO environment and the public environment are “1”, whereas the countermeasure flag corresponding to the other environment is “0”. While an environment that needs a countermeasure is identified by comparing the conditions of the vulnerability profile 701 and the conditions of the environment profile 801, it is also possible to use an analysis by AI.

A vulnerability countermeasure setting generation unit 431 generates, for each MFP managed by the management server 120, the vulnerability countermeasure setting 501 or 502 for the vulnerabilities collected by the vulnerability information collection unit 411. The vulnerability countermeasure setting generation unit 431 generates a vulnerability countermeasure setting for each MFP using the vulnerability information collected by the vulnerability information collection unit 411, the MFP-network environment correspondence table 601, and the environment-vulnerability countermeasure table 901. First, the vulnerability information collected by the vulnerability information collection unit 411 is analyzed, and a setting target that needs to be changed for a vulnerability countermeasure and a setting value of the setting target are determined. For example, the publicly-known vulnerability databases, such as the JVN and the CVE, include descriptions about vulnerability countermeasures, and possible attack target protocols/ports and a version to be set or a setting value, such as “enable” or “disable”, are described therein. The vulnerability countermeasure setting generation unit 431 identifies a vulnerability countermeasure target setting and a setting value of the vulnerability countermeasure target setting based on the foregoing descriptions. The countermeasure flag is then set for the MFP described in “target model”. The MFP-network environment correspondence table 601 describes the network environment identifiers of the MFPs 100 and 160, and the environment-vulnerability countermeasure table 901 describes, for each network environment identifier, information indicating whether a countermeasure is necessary. The countermeasure flag for the vulnerability countermeasure setting target model is determined based on the above-described information.

A process of generating the vulnerability countermeasure setting 501 or 502 for the vulnerability A will now be described with reference to FIG. 5. The vulnerability countermeasure setting 501 is a vulnerability countermeasure setting for the vulnerability A of the MFP 160. The vulnerability A is a vulnerability with respect to SMB, and in a case where SMB is used, there is a possibility of leakage of confidential information, so that the SMB setting should be set to “OFF”. Thus, the setting target of the vulnerability countermeasure setting 501 is “SMB”, and the setting value corresponding to the setting target is “OFF”. Further, the network environment identifier of the MFP 160 is “public” according to the MFP-network environment correspondence table 601. Since the countermeasure flag corresponding to the public environment with respect to the vulnerability A is “1” according to the environment-vulnerability countermeasure table 901, the countermeasure flag corresponding to the MFP 160 in the vulnerability countermeasure setting 501 is “1”. The vulnerability countermeasure setting 502 is a vulnerability countermeasure setting for the vulnerability B with respect to the MFP 160. The vulnerability B is a vulnerability that confidential information may be leaked in a case where the version 1.1 or lower is used, so that the version 1.2 or higher should be used. Thus, the setting target of the vulnerability countermeasure setting 502 is “TLS”, and the setting value of the setting target is “1.2”. Further, the network environment identifier of the MFP 100 is “intranet” according to the MFP-network environment correspondence table 601. Since the countermeasure flag corresponding to the intranet environment with respect to the vulnerability B is “0” in the environment-vulnerability countermeasure table 901, the countermeasure flag corresponding to the MFP 160 in the vulnerability countermeasure setting 501 is “0”. As described above, the management server 120 generates a vulnerability countermeasure setting for each of the MFPs 100 and 160 being managed by the management server 120.

A vulnerability countermeasure setting transmission unit 432 delivers, to the MFPs 100 and 160, the vulnerability countermeasure settings 501 and 502 generated by the vulnerability countermeasure setting generation unit 431. The delivery target MFPs are identified by referring to the item “target model” of the vulnerability countermeasure settings 501 and 502. For example, the delivery target of the vulnerability countermeasure setting 501 is the MFP 100, and the delivery target of the vulnerability countermeasure setting 502 is the MFP 160.

### (Processing Flow According to First Exemplary Embodiment)

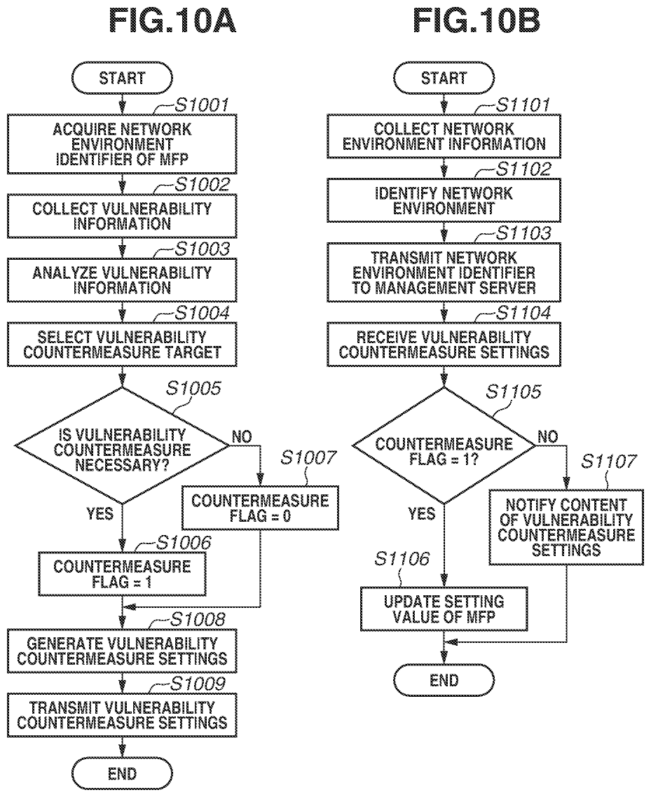

A processing flow of delivering a vulnerability countermeasure setting only to an MFP that needs a vulnerability countermeasure according to the present exemplary embodiment will now be described with reference to flowcharts in FIGS. 10A and 10B. FIG. 10A is a process performed by the management server 120, and FIG. 10B is a process performed by the MFP 100.

A process in which the management server 120 identifies a network environment that needs a vulnerability countermeasure and transmits a countermeasure setting will be described with reference to FIG. 10A. In step S1001, the network environment identifier acquisition unit 401 of the management server 120 acquires a network environment identifier of a management target MFP. In step S1002, the vulnerability information collection unit 411 collects vulnerability information from an external database or the like. In step S1003, the vulnerability information analysis unit 412 analyzes the collected vulnerability information. In step S1004, the vulnerability countermeasure target selection unit 421 selects a vulnerability countermeasure target environment. In step S1005, the vulnerability countermeasure target selection unit 421 determines whether a countermeasure is necessary based on the vulnerability analysis results and the network environment profiles for each environment. In a case where a vulnerability countermeasure is necessary (YES in step S1005), the processing proceeds to step S1006. In step S1006, the countermeasure flag for the environment is set to “1”, whereas in a case where no vulnerability countermeasure is necessary (NO in step S1005), the processing proceeds to step S1007. In step S1007, the countermeasure flag is set to “0”. In step S1008, the vulnerability countermeasure setting generation unit 431 generates a vulnerability countermeasure setting. In step S1009, the vulnerability countermeasure setting transmission unit 432 transmits the generated countermeasure setting to the MFP 100.

A process for applying a vulnerability countermeasure setting by the MFP 100 will be described with reference to FIG. 10B. In step S1101, after operation is started or a user operation is performed, the network environment information collection unit 320 collects network environment information about the network environment to which the MFP 100 is connected. In step S1102, the network environment identification unit 321 identifies the network environment of the MFP 100 based on the collected network environment information. In step S1103, the network environment identifier transmission unit 322 transmits device information about the MFP 100 and the network environment identifier to the management server 120 and waits until a vulnerability countermeasure setting is received. In step S1104, the vulnerability countermeasure setting reception unit 330 receives the vulnerability countermeasure setting transmitted from the management server 120. In step S1105, the security setting management unit 331 determines whether a countermeasure is necessary based on the countermeasure flag in the vulnerability countermeasure setting. In a case where the countermeasure flag is “1” (YES in step S1105), the processing proceeds to step S1106. In step S1106, the setting values of the MFP 100 are updated based on the vulnerability countermeasure setting. In a case where the countermeasure flag is “0” (NO in step S1105), the processing proceeds to step S1107. In step S1107, the content of the vulnerability countermeasure setting is notified to the administrator without updating the settings of the MFP 100.

In here, a case where the MFP 100 after transmitting device information and network environment identifier to the management server 120 waits until a vulnerability countermeasure setting is received is described above as an example. However, it is also possible to wait in the background and perform other processing.

According to the present exemplary embodiment, a vulnerability countermeasure setting is delivered only to an MFP that needs a vulnerability countermeasure, as described above.

### Modified Example 1 of First Exemplary Embodiment

In the above-described case according to the first exemplary embodiment, a countermeasure is determined as being necessary only in a case where the conditions of the vulnerability profile 701 match the conditions of the environment profile 801. According to the present modified example, it is determined whether a vulnerability countermeasure is necessary based on a vulnerability severity in addition to the matching of the conditions.

In the publicly-known vulnerability scoring systems, such as CVSS, the severity of a vulnerability is scored, and different numerical values indicate different levels of urgency of addressing the vulnerability. For example, in a case where the severity of a vulnerability is 10, it is determined that the vulnerability needs to be addressed urgently. In a case where the severity is 1, the impact of the vulnerability is low, so that it is determined that attention is required. According to the present modified example, it is determined that a vulnerability needs a countermeasure in a case where the severity score of the vulnerability is higher than or equal to a predefined value in addition to the matching of the conditions of the vulnerability profile and the conditions of the environment profile. For example, a countermeasure for a vulnerability is determined as being necessary only in a case where the vulnerability has a CVSS severity score of 7 or higher, which is determined as high level. In a case where the severity score is lower than 7, even if the conditions match, the countermeasure setting is not changed, and only the notification to the administrator is performed. While a case where the CVSS severity scores are used as a predetermined threshold in the vulnerability severity determination is described above as an example according to the present modified example, it is also possible to use other indicators.

### Modified Example 2 of First Exemplary Embodiment

While a case where the settings of the MFP 100 are changed based on the vulnerability countermeasure setting 501 or 502 transmitted by the management server 120 is described above as an example according to the first exemplary embodiment, the settings are changed only in a case where the management server 120 is successfully authenticated by the MFP 100 according to the present modified example.

While the management server 120 can change the settings of the MFP 100, a malicious third party can pretend to be the management server 120 and transmit a false vulnerability countermeasure setting to weaken the security setting of the MFP 100 intentionally. To protect against such foregoing threat, the MFP 100 performs authentication of the management server 120. The authentication of the management server 120 can be performed using, for example, an authentication method using a server certificate of the management server 120. The MFP 100 verifies the validity of the server certificate transmitted by the management server 120, and only in a case where the verification is successful, the MFP 100 changes the settings of the MFP 100 based on the vulnerability countermeasure setting 501 or 502. In a case where the authentication of the management server 120 fails, the settings are not changed. While a case where the authentication of the management server 120 is performed using the server certificate is described above as an example, it is also possible to use another method to perform the authentication of the management server 120.

### Modified Example 3 of First Exemplary Embodiment

In the first exemplary embodiment, the settings of the MFP 100 are changed based on the settings described in the vulnerability countermeasure setting 501 or 502 in a case where the MFP 100 is in an environment that needs a vulnerability countermeasure. According to the present modified example, a setting value of a setting that relates to an important resource is also changed in addition to the settings described in the vulnerability countermeasure setting 501 or 502.

A resource handled by the MFP 100 is a printed material, and personal information or confidential information may be described on the printed material, so that the printed material needs to be protected as an important resource. The MFP 100 has a function for protecting a printed material. Examples include a job-hold function of forcibly holding a print job in the MFP 100 during printing until the user is authenticated and a transmission destination restriction function of allowing transmission of scan data only to a destination registered in an address book. For example, in a case where a third party attempts to exploit a vulnerability to carry out an attack by causing an MFP to print a great number of printed materials to put a load on the MFP 100 and to waste ink, the unauthorized printing can be prevented by enabling the job-hold function. Further, in a case where a third party attempts to exploit a vulnerability to carry out unauthorized transmission of scan data to a destination of the third party, the transmission of the scan data to the destination of the third party can be prevented by enabling the transmission destination restriction function. In a case where the MFP 100 is determined as being in an environment that needs a vulnerability countermeasure, the security setting management unit 331 enables the above-described printed material protection settings in addition to the settings described in the vulnerability countermeasure setting 501 or 502 to protect the important resource.

### Modified Example 4 of First Exemplary Embodiment

A case where the management server 120 acquires a network environment identifier from a management target MFP and then collects vulnerability information is described above as an example according to the first exemplary embodiment. In the present modified example, the collection and analysis of vulnerability information are performed regardless of whether a network environment identifier is acquired.

The vulnerability information is updated daily, and in order to address a vulnerability promptly, the collection and analysis of vulnerability information need to be performed constantly. Thus, the management server 120 collects and analyzes vulnerability information regardless of the performance of the management target MFP, and in a case where vulnerability information relating to the MFP is detected, the management server 120 delivers a vulnerability countermeasure setting to the management target MFP.

Information processing according to a second exemplary embodiment of the present disclosure will now be described. Each component according to the second exemplary embodiment that corresponds to a component according to the first exemplary embodiment is assigned the same reference numeral as the corresponding component, and detailed descriptions thereof are omitted.

According to the first exemplary embodiment, the management server 120 determines whether a vulnerability countermeasure is necessary. According to the second exemplary embodiment, however, the MFP 100 determines whether a vulnerability countermeasure is necessary.

### (Functional Configuration According to Second Exemplary Embodiment)

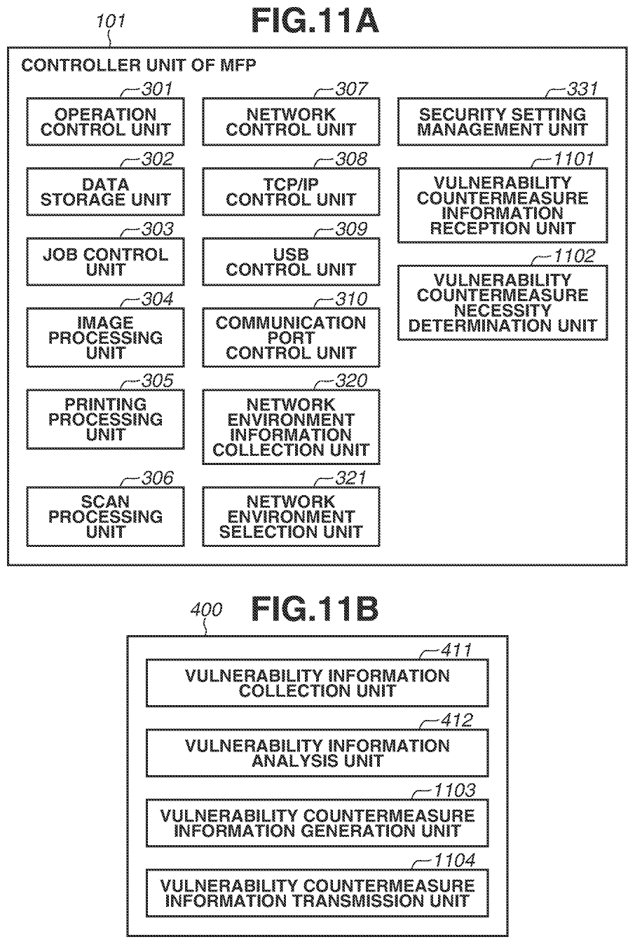

Functional configurations of the MFP 100 and the management server 120 according to the second exemplary embodiment will be described with reference to block diagrams illustrated in FIGS. 11A and 11B. FIG. 11A is a diagram illustrating a functional configuration of the MFP 100, and FIG. 11B is a diagram illustrating a functional configuration of the management server 120. Each component of the functional configurations of the MFP 100 and the management server 120 that corresponds to a component described above with reference to FIG. 3 or 4 is assigned the same reference number as the corresponding component, and descriptions thereof are omitted. Only the differences from the first exemplary embodiment will be described below.

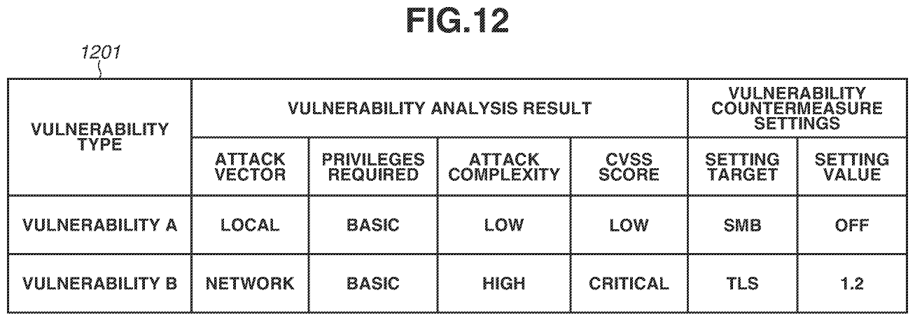

A vulnerability countermeasure information reception unit 1101 of the MFP 100 receives vulnerability countermeasure information 1201, illustrated in below-described FIG. 12, transmitted from the management server 120. The vulnerability countermeasure information 1201 is used by the MFP 100 in determining whether a vulnerability countermeasure and in configuring the vulnerability countermeasure setting. The vulnerability countermeasure information 1201 describes information that is generated by a vulnerability countermeasure information generation unit 1103 of the management server 120 and is necessary in determining whether a vulnerability countermeasure is necessary. For example, the vulnerability countermeasure information 1201 describes the metrics “Attack Vector”, “Privileges Required”, and “Attack Complexity” of the vulnerabilities A and B as results of vulnerability analysis by the management server 120. Furthermore, the setting targets and the setting values for applying a vulnerability countermeasure are additionally described.

A vulnerability countermeasure necessity determination unit 1102 of the MFP 100 determines whether a vulnerability countermeasure is necessary using the vulnerability countermeasure information 1201 received by the vulnerability countermeasure information reception unit 1101 and the environment profile 801 held in advance by the MFP 100. The vulnerability countermeasure necessity determination unit 1102 compares the vulnerability analysis results described in the vulnerability countermeasure information 1201 and the conditions described in the environment profile 801. In a case where an environment profile corresponding to a network environment identified by the network environment identification unit 321 matches the conditions of the vulnerability analysis results, it is determined that a vulnerability countermeasure is necessary.

Then, the settings described in the vulnerability countermeasure setting of the vulnerability countermeasure information 1201 are reflected via the security setting management unit 331. In a case where the conditions do not match, only the notification of the information described in the vulnerability countermeasure information 1201 to the administrator is performed, and the settings are not updated.

The vulnerability countermeasure information generation unit 1103 of the management server 120 generates the vulnerability countermeasure information 1201 on the basis of the vulnerability analysis results from the vulnerability information collected by the vulnerability information collection unit 411 and the analysis results of the vulnerability information analysis unit 412.

A vulnerability countermeasure information transmission unit 1104 of the management server 120 transmits the vulnerability countermeasure information 1201 to every MFP being managed under the management server 120.

### (Processing Flow According to Second Exemplary Embodiment)

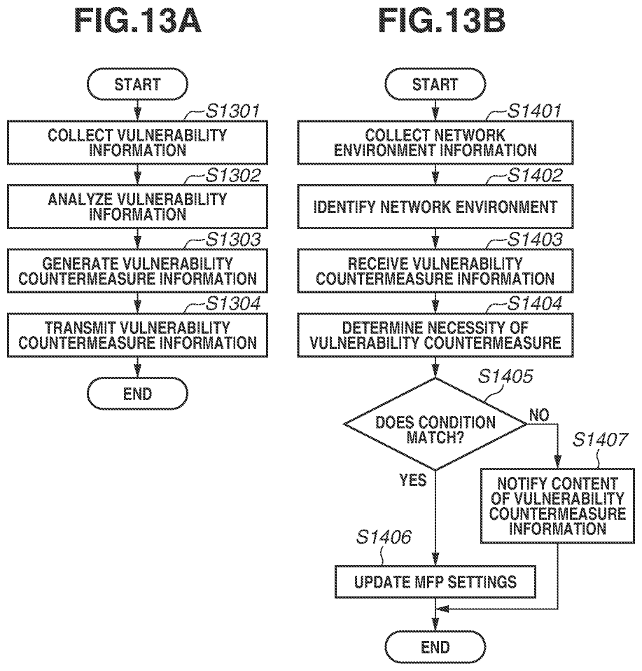

A process of determining whether a vulnerability countermeasure is necessary by the MFP 100 based on vulnerability countermeasure information 1201 generated by the management server 120 according to the present exemplary embodiment will now be described with reference to FIGS. 13A and 13B. FIG. 13A illustrates a process that is performed by the management server 120, and FIG. 13B illustrates a process that is performed by the MFP 100.

A process in which the management server 120 generates the vulnerability countermeasure information 1201 and transmits the vulnerability countermeasure information 1201 to the MFP 100 will be described with reference to FIG. 13A. In step S1301, the vulnerability information collection unit 411 of the management server 120 collects vulnerability information from an external database or the like. In step S1302, the vulnerability information analysis unit 412 analyzes the collected vulnerability information. In step S1303, the vulnerability countermeasure information generation unit 1103 generates the vulnerability countermeasure information 1201. In step S1304, the vulnerability countermeasure information transmission unit 1104 then transmits the vulnerability countermeasure information 1201 to all of the MFPs being managed by the management server 120.

A process of determining whether a vulnerability countermeasure is necessary by the MFP 100 will be described with reference to FIG. 13B. In step S1401, after operation of the MFP 100 is started or a user operation is performed, the network environment information collection unit 320 collects network environment information about the network environment to which the MFP 100 is connected. In step S1402, the network environment identification unit 321 identifies the network environment of the MFP 100 based on the collected network environment information. In step S1403, the vulnerability countermeasure information reception unit 1101 receives the vulnerability countermeasure information 1201 from the management server 120. In step S1404, the vulnerability countermeasure necessity determination unit 1102 determines whether a vulnerability countermeasure is necessary based on the vulnerability countermeasure information 1201. In step S1405, the vulnerability information analysis results described in the vulnerability countermeasure information 1201 and the conditions described in the environment profile 801 are compared, and in a case where the conditions match (YES in step S1405), the processing proceeds to step S1406. In step S1406, the security setting management unit 331 updates the settings of the MFP 100. In a case where the conditions do not match (NO in step S1405), the processing proceeds to step S1407. In step S1407, the content of the vulnerability countermeasure information is notified to the administrator. The MFP 100 determines whether a vulnerability countermeasure is necessary based on the vulnerability countermeasure information generated by the management server 120, as described above.

Information processing according to a third exemplary embodiment of the present disclosure will now be described. Each component according to the third exemplary embodiment that corresponds to a component according to the first and second exemplary embodiments is assigned the same reference numeral as the corresponding component, and redundant detailed descriptions thereof are omitted.

According to the first and second exemplary embodiments, the management server 120 collects and analyzes vulnerability information. According to the present exemplary embodiment, the MFP 100 collects and analyzes vulnerability information.

### (Functional Configuration According to Third Exemplary Embodiment)

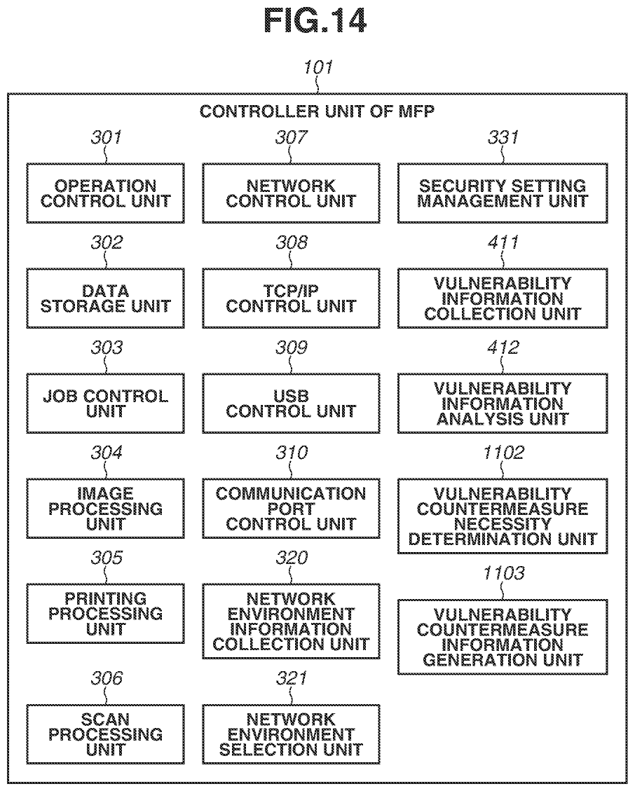

A functional configuration of the MFP 100 according to the third exemplary embodiment will now be described with reference to a block diagram in FIG. 14. Since the functional configuration of the MFP 100 is described above with reference to FIGS. 3, 4, 11A, and 11B, the same reference numerals are assigned, and redundant descriptions thereof are omitted.

### (Processing Flow According to Third Exemplary Embodiment)

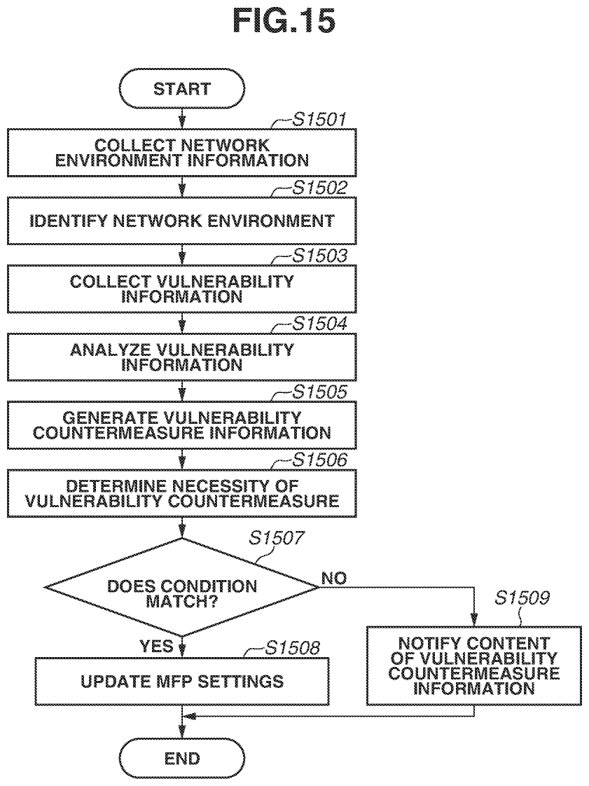

A process in which the MFP 100 collects vulnerability information and determines whether a vulnerability countermeasure is necessary according to the present exemplary embodiment will now be described with reference to FIG. 15.

In step S1501, after operation of the MFP 100 is started or a user operation is performed, the network environment information collection unit 320 collects network environment information about the network environment to which the MFP 100 is connected. In step S1502, the network environment identification unit 321 identifies the network environment of the MFP 100 based on the collected network environment information. In step S1503, the vulnerability information collection unit 411 of the MFP 100 collects vulnerability information from an external database. In step S1504, the vulnerability information analysis unit 412 analyzes the collected vulnerability information. In step S1505, the vulnerability countermeasure information generation unit 1103 generates the vulnerability countermeasure information 1201. In step S1506, the vulnerability countermeasure necessity determination unit 1102 determines whether a vulnerability countermeasure is necessary based on the vulnerability countermeasure information 1201. In step S1507, the vulnerability information analysis results described in the vulnerability countermeasure information 1201 and the conditions described in the environment profile 801 are compared. In a case where the conditions match (YES in step S1507), the processing proceeds to step S1508. In step S1508, the security setting management unit 331 updates the settings of the MFP 100. In a case where the conditions do not match (NO in step S1507), the processing proceeds to step S1509. In step S1509, the content of the vulnerability countermeasure information is notified to the administrator. The MFP 100 collects and analyzes vulnerability information, and determines whether a vulnerability countermeasure is necessary, as described above.

### OTHER EMBODIMENTS

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-165567, which was filed on Oct. 14, 2022 and which is hereby incorporated by reference herein in its entirety.

What is claimed is:

1. A server apparatus comprising:
one or more memories; and
one or more processors, wherein the one or more processors and the one or more memories are configured to:
acquire vulnerability information about an information processing apparatus;
acquire information about a network to which the information processing apparatus is connected; and
transmit, to the information processing apparatus, vulnerability countermeasure information based on the vulnerability information and the information about the network.

2. The server apparatus according to claim 1, wherein the information about the network is an identifier configured to identify security of the network to which the information processing apparatus is connected.

3. The server apparatus according to claim 1, wherein the one or more processors and the one or more memories are further configured to acquire the information about the network from a network device within the network to which the information processing apparatus is connected.

4. The server apparatus according to claim 1, wherein the one or more processors and the one or more memories are further configured to acquire the vulnerability information, based on information about at least one of a protocol, a port, software, and hardware that are used in the information processing apparatus.

5. The server apparatus according to claim 1, wherein the one or more processors and the one or more memories are further configured to acquire the vulnerability information, based on information about at least one of a vendor name, a device name, and a model number of the information processing apparatus.

6. The server apparatus according to claim 1, wherein the one or more processors and the one or more memories are further configured to generate the vulnerability countermeasure information, based on attack information about the vulnerability information and a vulnerability severity in the vulnerability information.

7. The server apparatus according to claim 1, wherein the one or more processors and the one or more memories are further configured to, in a case where network information specified by the vulnerability information matches the information about the network, transmit the vulnerability information to the information processing apparatus.

8. The server apparatus according to claim 1, wherein the vulnerability countermeasure information includes a setting target in which a setting value is to be changed in the information processing apparatus, the setting value after a change, and necessity for a vulnerability countermeasure.

9. The server apparatus according to claim 6, wherein the one or more processors and the one or more memories are further configured to, in a case where the vulnerability severity in the vulnerability information is greater than a predetermined value, transmit the vulnerability information to the information processing apparatus.

10. The server apparatus according to claim 1, wherein the one or more processors and the one or more memories are further configured to, in a case where authentication by the information processing apparatus is successful, transmit the vulnerability information to the information processing apparatus.

11. An information processing apparatus comprising:
one or more memories; and
one or more processors, wherein the one or more processors and the one or more memories are configured to:
acquire vulnerability countermeasure information;
acquire information about a network being connected; and
determine whether to apply the vulnerability countermeasure information, based on the information about the network.

12. The information processing apparatus according to claim 11, further comprising:
a printing unit configured to print a printed material,
wherein the one or more processors and the one or more memories are further configured to protect the printed material.

13. The information processing apparatus according to claim 11, wherein the one or more processors and the one or more memories are further configured to acquire the vulnerability countermeasure information from a server apparatus.

14. A non-transitory storage medium storing computer-executable instructions that, when executed by a server apparatus, cause the server apparatus to execute an information processing method, the information processing method comprising:
acquiring vulnerability information about an information processing apparatus;
acquiring information about a network to which the information processing apparatus is connected; and
transmitting, to the information processing apparatus, vulnerability countermeasure information based on the vulnerability information and the information about the network.

15. A non-transitory storage medium storing computer-executable instructions that, when executed by a server apparatus, cause the information processing apparatus to execute an information processing method, the information processing method comprising:
acquiring vulnerability countermeasure information;
acquiring information about a network being connected; and
determining whether to apply the vulnerability countermeasure information, based on the information about the network.
